(19) United States
(12) Patent Application Publication
(10) Pub. No.: US 2004/0234677 A1
(43) Pub. Date: Nov. 25, 2004

(54) Mixer for coating an ion-conducting polymer on a powdered substance and method for coating the same

(75) Inventors: Takaya Sato, Chiba-shi (JP); Tatsuo Shimizu, Tokyo (JP)

Correspondence Address: APEX JURIS, PLLC, 13194 EDGEWATER LANE NORTHEAST, SEATTLE, WA, 98125, US

(73) Assignees: Nisshinbo Industries, INC., Tokyo (JP); Itochu Corp., Osaka-shi (JP)

(21) Appl. No.: 10/793,975

(22) Filed: Mar. 5, 2004

Related U.S. Application Data
(63) Continuation-in-part of application No. 09/807,212, filed on Apr. 11, 2001, now abandoned.

(30) Foreign Application Priority Data
Aug. 12, 1999 (JP) 11-262501
Aug. 11, 2000 (WO) PCT/JP00/05397

(51) Int. Cl. B05D 7/00; B05D 1/00

(52) U.S. Cl. 427/11; 427/212; 366/64; 366/279

(57) ABSTRACT

A mixer and a method for mixing and press-sliding a mixture of an ion-conducting polymer or a raw material of the ion-conducting polymer with a powdered substance 11 are disclosed. Due to the effective press-sliding process of this invention, the powdered substance 11 is effectively coated with the ion-conducting polymer 12.

This application is a continuation-in-part of U.S. patent application Ser. No. 09/807,212.

### FIELD OF THE INVENTION

This invention relates to a mixer for coating an ion-conducting polymer on a powdered substance and a method for coating the ion-conducting polymer on a powdered substance. The powdered substance coated with the ion-conducting polymer is widely used for such as an electrode structure for an electrical component, such as a primary and secondary cell, and an electric double layer capacitor.

### BACKGROUND OF THE INVENTION

Conventional arts will be explained with reference to FIGS. 16-19. In the conventional art, in a lithium ion battery, a positive electrode h is manufactured by mixing a mixture e of a powdered electrode active substance a comprising LiCoO2, powdered electrically-conducting carbon b, a binder polymer c and a solvent d into a slurry, and applying it to a current-collecting material f to form a compound film g, as shown in FIG. 16. The compound film g is a partial enlargement of the mixture e on the current-collecting material f.

A negative electrode i is manufactured by mixing the mixture e of the powdered electrode active substance a comprising powdered graphite, the binder polymer c and the solvent d into a slurry, applying it to the current-collecting material f, and drying to form the compound film g, as shown in FIG. 17.

The mixing is performed for example by a planetary mixer as shown in FIG. 19. The mixture is held in a container, and a mixing blade is rotated so the mixture forms a slurry.

A lithium secondary cell contains an electrolyte j between the positive electrode h and negative electrode i, a separator k being disposed in the electrolyte j, as shown in FIG. 18.

However, concerning the electrode active substance a contained in the compound film g, doping/undoping of lithium ions is performed during charging and discharging through the electrolyte j which permeated the voids in the compound film j, and if the particles of the electrode active substance a are covered by the binder polymer c, lithium ions are prevented from penetrating the electrode active substance a, so battery performance declines.

Even if there are minute interstices on the surfaces of the electrode active substance particles a covered by the binder polymer c, the electrolyte j cannot penetrate them, so passage of lithium ions is blocked and the battery characteristics decline.

If the amount of the added binder polymer c is reduced in an attempt to increase the interstices on the particle surfaces of the electrode active substance a, the strength of the compound film g decreases, so cohesion between the electrode active substance a or electron-conducting assistant and the current-collecting material f gradually declines during repeated charges and discharges of the battery, and battery performance declines due to decrease of electron-conducting properties.

As a means of resolving this problem, Japanese Patent Laid-Open Hei 10-106540 discloses a method of forming the binder polymer c as a mesh. However, even if the electrode active substance a is made to adhere in a mesh-like fashion by the binder polymer c, the binder polymer c which is used is a non-ion conducting polymer, so ions cannot penetrate or move through the binder polymer c. Therefore, in this case also, penetration of lithium ions into the electrode active substance a is blocked as in the case of a conventional electrode. As a result, the battery performance declines.

In U.S. Pat. No. 5,641,590 (Japanese Patent Laid-Open Hei 9-50824), the inventors disclose a method for manufacturing electrodes wherein an ion-conducting polymer is added to the electrode instead of the conventional binder polymer c which does not have ion-conducting properties. However, in this case, the ion-conducting polymer itself has a weak adhesive force, and as it is merely added to the electrode active substance a when the compound film g is manufactured, it does not permit manufacture of a battery having satisfactory performance.

Batteries are used for various types of electrical components, and they have to satisfy stringent safety criteria with regard to fire, etc. In the case of a lithium-ion battery, oxygen is generated if the LiCoO2 is heated to high temperature and as there is a risk of explosion or fire if a large current flows due to a short-circuit, safety is a prime consideration.

### DISCLOSURE OF THE INVENTION

It is an object of this invention to provide a device wherein an ion-conducting polymer is efficiently coated on a powdered substance and a method of efficiently coating an ion-conducting polymer on a powdered substance.

This invention relates to a mixer which treats a mixture of an ion-conducting polymer or ion-conducting polymer raw material and a powdered substance so as to coat the powdered substance with the ion-conducting polymer, the mixer comprising a container having an inner bottom surface and containing the mixture and a main blade which rotates or moves relative to the inner bottom surface of the container. An area ratio of a lower surface of the main blade facing the inner bottom surface of the container relative to the inner bottom surface of the container is approximately 5 to 70 percent. The mixture is press-slid between the inner bottom surface of the container and the lower surface of the main blade facing therewith.

This invention further relates to a coating method wherein a mixture of an ion-conducting polymer or ion-conducting polymer raw material and powdered substance are press-slid between a lower surface of a main blade and a inner bottom surface of a container, where an area ratio of the lower surface of the main blade relative to the inner bottom surface of the container is approximately 5 to 70 percent. The ion-conducting polymer or ion-conducting polymer raw material is coated on a powdered substance.

### BRIEF DESCRIPTION OF THE DRAWINGS

The above and other objects of the present invention will become readily apparent by reference to the following detailed description when considered in conjunction with the accompanying drawings wherein:

FIG. 1 is a diagram when coating a powdered active substance with an ion-conducting polymer;

FIG. 2(A) is a descriptive diagram of the mixer of this invention;

FIG. 2(B) is a perspective view of the blade in the plate-like wing shape;

FIG. 2(C) is a cross-section view of the blade of FIG. 2(B) as press-sliding;

FIG. 2(D) is a cross-section view of the blade with a curved-lower surface;

FIG. 3(A) is a schematic view of the mixer wherein the inner bottom surface of the container is flat;

FIG. 3(B) is a perspective view of another blade in the disc-like shape with the through holes corresponding to the inner bottom surface of the container in FIG. 3(A);

FIG. 4(A) is a perspective view of another blade with a wide-bottom surface;

FIG. 4(B) is a perspective view of another blade in the disc-like shape with notched grooves;

FIG. 4(C) is another schematic view of the mixer;

FIG. 5 is a diagram showing the manufacture of an electrode structure comprising an electrode active substance which supplies ions;

FIG. 6 is a diagram of an electrode structure comprising an electrically conducting substance wherein electricity moves between ions;

FIG. 7(A) is a schematic view of the secondary cell with the separator;

FIG. 7(B) is a schematic view of the secondary cell without the separator;

FIG. 8 is another schematic view of the mixer;

FIG. 9 is a lateral view of the mixer in FIG. 8;

FIG. 10 is a descriptive diagram of a cohesion device;

FIG. 11(A) is an electron micrograph of LiCoO2 which has not received any processing;

FIG. 11(B) is a schematic diagram of FIG. 11(A);

FIG. 12(A) is an electron micrograph of a positive electrode structure obtained in a comparative example 3.

FIG. 12(B) is a schematic diagram of FIG. 12(A)

FIG. 13(A) is an electron micrograph of a positive electrode structure obtained in the third embodiment;

FIG. 13(B) is a schematic diagram of FIG. 13(A);

FIG. 14 is another electron micrograph of a positive electrode structure obtained in the third embodiment;

FIG. 15 is a photograph of a positive electrode structure obtained secondary electronic image of the positive electrode structure obtained in the third embodiment

FIG. 16 is a diagram of the conventional art showing the manufacture of an electrode structure comprising an electrode active substance which supplies ions;

FIG. 17 is a diagram of an electrode structure of the conventional art comprising an electrically conducting substance wherein electricity moves between ions;

FIG. 18 is a schematic view of a secondary cell of the conventional art; and

FIG. 19 is a front cross-section view of the mixer of the conventional art.

This invention will now be described in more detail referring to the drawings. The terms regarding the direction including but not limited to “right” and “left” or “upper” and “lower” and singular and non-singular terms are not intended to limit the scope of this invention and are used merely for the explanation purpose.

(a) Mixer

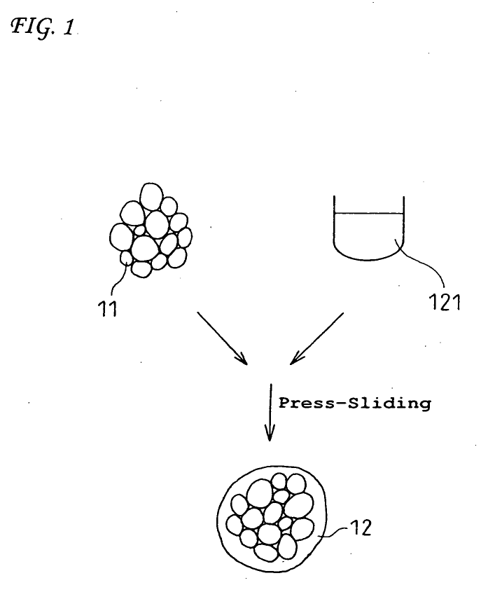

As is shown in FIG. 1, a mixer press-slides mixtures of the ion-conducting polymer or its raw material 121 with the powdered substance 11 so as to coat the ion-conducting polymer 12 on the powdered substance 11.

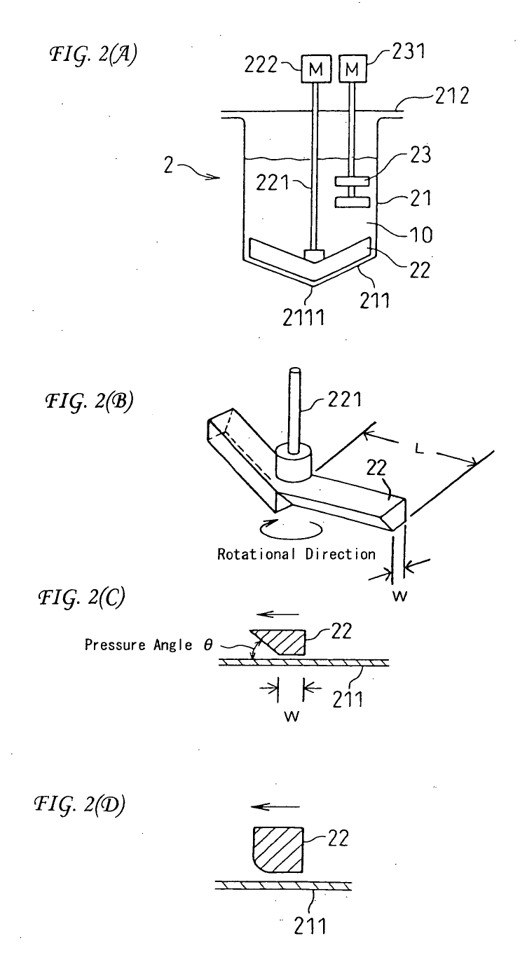

An example of the mixer is shown in FIG. 2. The mixture 10 of the ion-conducting polymer 12 or its raw material with the powdered substance 11, or the mixture 10 comprising this mixture and a solvent or the like, is introduced into a container 21, and the main blade 22 is rotated. A gap is reserved between an inner bottom surface 211 of the container 21 and a lower surface of the main blade 22 directly facing the inner bottom surface 211. When the main blade 22 is rotated, an amount of the mixture 10 enters the gap between the inner bottom surface 211 of the container and the lower surface of the main blade 22. The mixture is press-slid. This process is repeated so that the ion-conducting polymer 12 or its raw material coats the powdered substance 11 effectively.

If necessary, the mixer 2 may have a dispersion blade 23 in the container 21. The dispersion blade 23 is rotated at high speed to disperse the press-slid mixture 10.

(b) Container

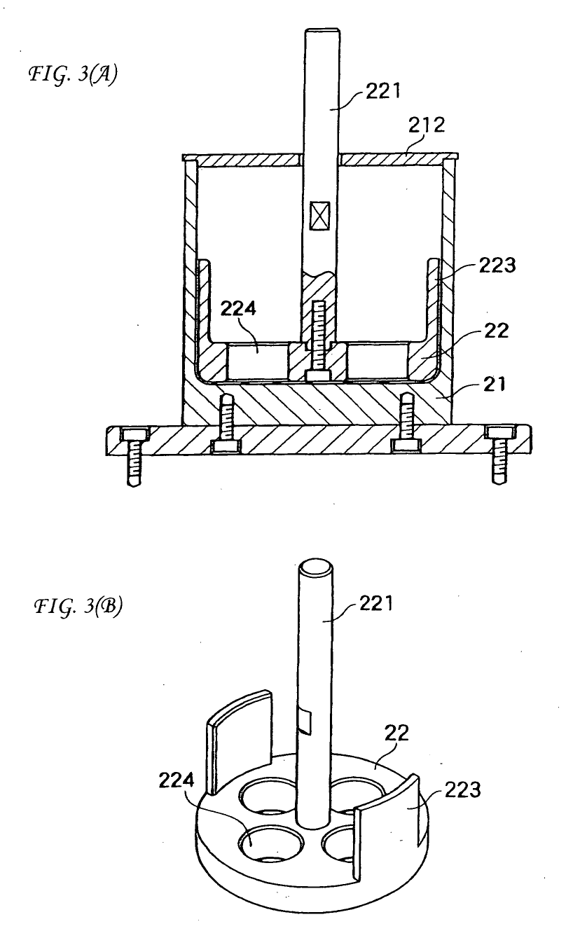

The container 21 is provided for keeping the mixture 10 therein in which the mixture 10 is press-slid and stirred. The inner bottom surface of the container 21 may be such as to permit press-sliding of the mixture 10, and may be slanting as in FIG. 2 or flat as in FIG. 3. For example, if it is slanting, it has a bottom part 2111, and slants upwards from the bottom part 2111 towards the circumference. The central part may be situated in a low position, and have a slope rising towards the circumference. The inner bottom surface 211 may be formed in the shape of, for example, a grinding mortar, and the angle of the bottom part 2111 may for example be 120 degrees. The inner bottom surface 211 of the container is wear-resistant, and is formed by thermal spraying with tungsten or carbide using SUS. More than one bottom part 2111 of this type may also be formed on the inner bottom surface 211.

(c) Main Blade

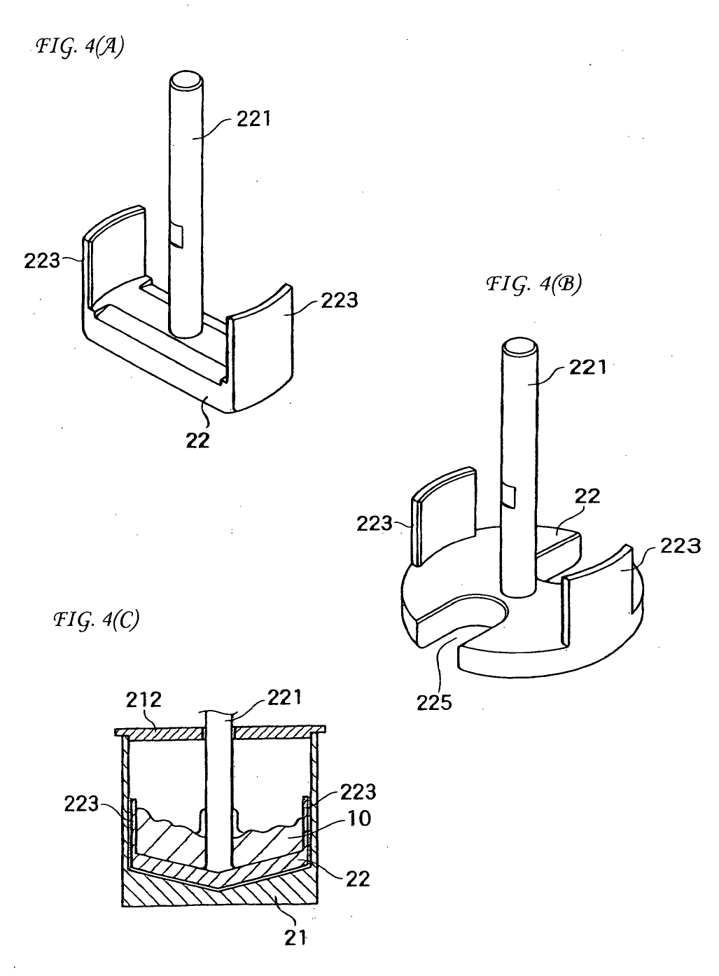

A slight gap exists between the lower surface of the main blade 22 and the inner bottom surface 211 of the container 21 but they functionally engage each other to cause press-sliding the mixture caught therebetween. The main blade may have a number of different shapes such as a plate-like blade as shown in FIG. 2(B) and a disc-like blade in FIG. 3(B) and FIG. 4(B). A blade in FIG. 4(A) can be fashioned into a wide blade so as to provide a larger surface area between the inner bottom surface of the container and the lower surface of the blade than the blade as shown in FIG. 2(B), thereby increasing the efficiency of press-sliding. If the main blade is disc-shaped, for example, the blade should have plural through holes 224 as is shown in FIG. 3(B) and notched grooves 225 as is shown in FIG. 4(B). The mixture enters into the through holes 224 in FIG. 3(B) or the notched groove 225 in FIG. 4(B) and is transported to a gap between the inner bottom surface 211 of the container 21 and the lower surface of the main blade 22 directly facing the inner bottom surface 211.

An area ratio of the lower surface of the main blade 22 facing the inner bottom surface 211 of the container 21 relative to the inner bottom surface is approximately 5 to 70 percent, preferably 10 to 70 percent or 15 to 70 percent. Preferable coating result cannot be expected if the area ratio goes below 5 percent or above 70 percent, and no efficient circulation and agitation of the mixture in the container 21 can be expected if the area ratio goes above 70 percent.

If the mixture adhering to the lateral surfaces of the container 21 is removed, stirring efficiency can be increased. For this purpose, members adjacent to the lateral surfaces of the container 21, for example scrapers 223, may be attached to the tip of the main blade 22 as shown in FIG. 3 or FIG. 4. The scrapers 223 rotate together with the main blade so that mixture in the vicinity of the lateral surfaces of the container 21 is scraped off, and is transported to the gap between the inner bottom surface 211 of the container 21 and the lower surface of the blade 22, thereby creating a condition for highly efficient press-sliding. At least, the tip of the main blade is designed to remove the mixture adhered to the lateral surface of the container, which may be provided away from the main blade 22 for the independent operation.

In FIG. 2(A) where the inner bottom surface 211 of the container 21 is slanting, the main blade 22 is designed to curve upwards along the inner bottom surface 211 of the container 21 from the bottom part 2111. The main blade 22 may comprise two blades extending from the central part of the whole main blade 22 as shown in FIG. 2(B) or more than two blades, e.g. 10 or more, depending on the amount and type of mixture. Instead of a large number of blades, a wide blade or blades having a wide base or bases may also be used such as in FIG. 4(A). Generally, a larger surface area for the press-sliding action of the mixture gives more efficient press-sliding.

The main blade is rotated by a main motor 222. The blade may be designed to rotate in any direction freely, which provides the mixer a capacity of performing more complex press-sliding control. A sympathetic flow may also be set up in the mixture due to the rotation of the main blade 22, so sympathetic flow is prevented by reversing the rotational direction of the main blade during the rotation. For example, forward rotation is performed for 10 seconds; the blade is stopped; and reverse rotation is then performed for 10 seconds. Press-sliding can be efficiently controlled by repeating this process. Practically, identical results for press-sliding were obtained when this back and forth reverse control was performed for approximately 30 minutes, and when rotation in the same direction was performed for approximately 3 hours. There are also many other rotational methods, for example the rotational angle can continuously suitably be varied like a sine curve, etc. The rotational speed of the main blade 22, i.e., the number of rotations, is set low, for example 120 rpm or less, when press-sliding is performed.

The gap between the inner bottom surface 211 of the container 21 and the lower surface of the main blade 22 is set as narrow as necessary for effective press-sliding the mixture. The distance between the two surfaces depends upon the capacity of the mixer 2 and the shape of the main blade 22. The distance can be 0.1 to 15 mm, preferably 0.3 to 5.0 mm, more preferably 0.5 to 3.0 mm. Press-sliding efficiency is reduced when the distance is below 0.1 mm or over 15 mm.

For the main blade 22 having the particular shape described in FIG. 2(B), it is preferable that the surface in the motion direction (press-sliding direction) of the main blade 22 is designed so that a pressing angle θ relative to the inner bottom surface 211 of the container 21 becomes an acute angle. For example, if the cross-section of the main blade 22 is a reverse trapezoid as shown in FIG. 2(C), the pressing angle is from 3 to 70 degrees. The cross-section of the main blade 22 may have a rounded corner as shown in FIG. 2(D). The material used as the main blade should have wear-resistant properties, which can be formed for example by thermal spraying with tungsten or carbide using SUS.

If a surface in a direction opposite to the motion direction (press-sliding direction) of the main blade 22 is formed for example effectively perpendicular to or at an obtuse angle to the inner bottom surface, the mixture 10 can be collected around the main shaft 221 by rotating the main shaft 221 in the reverse direction.

If there are plural bottom parts 2111 on the bottom surface 211, the central parts of the main blade 22 are also disposed in positions of the bottom part corresponding to their number. The press-sliding process is preferably performed for 3 to 7 hours.

(d) Press-Sliding

Press-sliding is an action of sliding while pressing mixtures 10 of the ion-conducting polymer 12 or the ion-conducting polymer raw material 12 and the powdered substance 11 together. An external force is applied to the mixtures so that they cohere to each other and the particles rotate, and this process is performed repeatedly to obtain a press-sliding product.

In this process, for example, the mixtures 10 are brought into mutual contact by applying the external force to the mixtures 10 between a lower surface of the main blade 22 and the inner bottom surface of the container 21, the mixtures 10 slide and rotate due to a rotation of the main blade 22, and an ion-conducting polymer or ion-conducting polymer raw material 121 is thereby coated on the powdered substance 11. This is performed repeatedly so that the ion-conducting polymer or ion-conducting polymer raw material 121 coats the whole surface of the powdered substance, and the ion-conducting polymer or ion-conducting polymer raw material 121 covers the surface of the powdered substance 11.

(e) Dispersing Blade

The dispersion blade 23 is intended to disperse the mixture 10 which has been press-slid by the main blade 22. The dispersion blade 23 is disposed in a position at which the mixture 10 can be dispersed, and it rotates at a high speed such as 1000 to 4000 rpm. Due to this high speed rotation, the ion-conducting polymer 12 or its raw material coated on the particle surfaces of the powdered substance 11 uniformly disperses through the whole of the powdered substance. The mixture adheres on the area surrounding the main shaft 221 of the main blade 22 when in firm mixing or low clay dispersion and tends to be non uniformed mixing. The dispersion blade 23 is positioned at the side of the main shaft 221 of the main blade 22, rotating the same from the dry mixing stage to prevent the adhesion on the area surrounding the main shaft 221.

(f) Powdered Electrode Active Substance

The powdered substance 11 has a small particle size, which is a powdered electrode active substance or a powdered electrically-conducting substance used, for example, in secondary cell electrodes or a powdered large surface material with a large surface area used in an electric double layer capacitor.

The powdered electrode active substance may be a material which permits insertion and separation of ions, or a α-conjugated electrically-conducting polymer material.

There is no particular limitation on the electrode active material used as the positive electrode in a non-aqueous electrolytic battery, but in the case of a rechargeable secondary cell, a chalcogen compound permitting insertion and separation of lithium ions or a complex chalcogen compound containing lithium may for example be used.

There is no particular limitation on the electrode active substance used as the negative electrode in a non-aqueous electrolyte battery, but a material permitting insertion and separation of lithium ions may be used such as lithium metal, lithium alloy (alloys of lithium and aluminum, lead and indium, etc.), and carbon materials.

Examples of π-conjugated conducting polymer materials are polyacetylenes, polyanilines, polypyrroles, polythiophenes, poly-ρ(para)-phenylenes, polycarbazoles, polyacenes and sulfur polymers.

The powdered electrically-conducting substance increases the electrical conductivity of the electrode structure, there being no particular limitation thereon, but metal powders and carbon powder may be used. As carbon powder, pyrolytic carbon such as carbon black and its graphitization products, artificial and natural scaly graphite powder, and carbon fiber and its graphitization products, are suitable. Mixtures of these carbon powders may also be used.

A powdered electrode substance with a large surface area is a powdered large surface material that may draw many ions on that surface. A preferable powdered large surface material has its specific surface area of 500 m2/g or larger, more preferably 1000 m2/g or larger, further more preferably 1500 m2/g-3000 m2/g, and its average particle diameter of 30 μm or lower, more preferably 5-30 μm carbon material. If the specific surface area and the average particle diameter are out of the above-specified range, and it may be difficult to secure a high electrostatic capacity and a low resistance electric double layer capacitor.

A preferable powdered large surface material especially is an activated carbon resulting from activating the carbon material such as by a steam activating treatment and a fused KOH activating treatment. The activated carbon for example may be palm shell activated carbon, a phenol activated carbon, a petroleum coke type activated carbon, and polyacenes. One of the above activated carbon types or combination of two ore more activated carbon types may be employed. Phenol activated carbon, a petroleum coke type activated carbon, and a polyacenes are preferable since they provide a larger electrostatic capacity.

(g) Ion-Conducting Polymer and Raw Material of Ion Conducting Polymer

The ion-conducting polymer and the raw material of the ion-conducting polymer are explained next. Both the ion-conducting polymer and the ion conducting polymer can dissolve at least the lithium salts described hereafter at a concentration of at least 0.1M (mole/l). Dissolution here means the condition that no crystallization occurs due to dissociation of Li+ion and pairing anion. In order to recognize the condition that the lithium salt is being dissolved within the polymer, the mixture of the polymer and lithium salt can be measured with a wide-angle x-ray scattering analysis, thereby finding no peak showing the existence of the crystal, or no birefringence as placed between two orthogonally positioned deflecting plates.

The ion-conducting polymer and the material of the same are the polymer and the material of the same having an electrical conductivity of 10-8 S at room temperature when the polymer and the polymer made of the material contains the lithium salt at a concentration of at least 0.1M. It is to be particularly preferred that the ion-conducting polymer dissolves at least lithium salts to a concentration of 0.8M-1.5M, the resulting polymer solution having an electrical conductivity of 10-3 S/cm-10-5 S/cm at room temperature.

The lithium salt is at least one type of lithium salt having ClO4—, CF3SO3—, BF4—, PF6—, AsF6—, SbF6-, CF3CO2— or (CF3SO2)2N— as anion.

According to this invention, either the ion-conducting polymer, the raw material of the ion-conducting polymer, or mixture of the same alone can be used.

The ion-conducting polymer has liner molecular structure and may further has branched liner polymer. Examples of the ion-conducting polymer of this type includes but not limited to hydroxyalkyl polysaccharides based on polysaccharides such as cellulose, amylose, and pullulan. Examples would be hydroxyethyl cellulose, hydroxypropyl cellulose, dihydroxypropyl cellulose, hydroxyethyl amylose, hydroxypropyl amylose, dihydroxypropyl amylose, hydroxypropylpullulan, and dihydroxypropylpullulan. Derivative introducing high polarity group such as cyanoethyl group therein often is used as hydroxyalkyl polysaccharides. Examples of derivative may be cyanoethylated dihydroxypropyl cellulose as disclosed in Japanese Laid-Open Patent Publication No. 8-225626 and the disclosure of which is incorporated herein.

Polyvinyl alcohol and its derivative for example is dihydroxypropylpolyvinylalcohol, cyanoethylated dihydroxypropylalcohol, or cyanoethylpolyvinylalcohol, which is disclosed in WO00/57440, WO00/56780, and WO02/087003 and the disclosure of which is incorporated herein. Polyglycidol such as cyanoethylated polyglycidol and its derivative may be employed, which is disclosed in WO01/95351, WO00/36017, and WO00/35991 and the disclosure of which is incorporated herein. Cyanoethylated polymer capable of increasing solubility within the polymer can often be used but alternatively, polyurethane resin, polyethylene oxide, polypropylene oxide, polyethylene succinate, poly-β-propyolactone, polyethyleneimine, polyalkylenesulfide, or ethylene oxide/propylene oxide random copolymer may be used.

The ion-conducting polymer raw material is a substance which produces the ion-conducting polymer with three-dimensional crosslinking due to covalent bond by chemical reaction such as crosslinking reaction, when energy is supplied externally. The energy causing this may be heat, ultraviolet light, light, electron radiation, or microwave.

Compounds having reactivity double bond may often be employed as the raw material for the ion-conducting polymer. Preferably, such compounds should have two or more of vinyl group, acrylic group, and methacrylic group within the molecule. Mixing with the substance having two or more reactivity double bond material may allow the substance with another substance having reactivity double bond to coexist. Examples of the substances are such the substance with two or more reactivity double bond within the molecular of such as divinylbenzene, divinylsulfone, and methacrylic acid and acrylic acid, etc. In addition, as necessary, for example, it is possible to add compounds having one acrylic acid group or methacrylic acid group within the molecular such as glycidylmethacrylate and glycidyl acrylate, acrylic amide compounds such as N-methylol acrylic amide and methylene bisacrylic amide, vinyl compounds such as vinyloxazoline and vinylene carbonate, or the compounds with other reactivity double bond.

Alternatively, as the raw material of the ion-conducting polymer, it is possible to use compounds with active oxygen such as polyol compounds and isocyanate compounds to be mixed, heated, and reacted, and the ion-conducting polymer of polyurethane can be employed.

Isocyanate compounds may be an alicyclic isocyanate, aliphatic isocyanate, and aromatic isocyanate so long as the molecule has at least two isocyanate groups. Illustrative examples of the isocyanate compound include methylenediphenyl diisocryanate (MDI), polymeric methylenediphenyl diisocryanate (polymeric MDI), tolylene diisocyanate (TDI), lysine diisocyanate (LDI), hydrogenated tolylene diisocyanate, hexamethylene diisocyanate (HDI). One of these alone or any combination (two or more) of the compounds may be employed.

Illustrative examples of the polyol compounds include but not limited to polyethylene glycol, polypropylene glycol, polymeric polyol such as ethylene glycol-polypropylene glycol copolymer, ethylene glycol, 1,2-propylene glycol, 1,3-propylene glycol, 1,3-butanediol, and 1,4-butanediol.

Of these polyol compounds, suitable examples of polyfunctional polyols include trifunctional polyethylene glycol, trifunctional polypropylene glycol, trifunctional (ethylene glycol-propylene glycol) random copolymers, difunctional polyethylene glycol, difunctional polypropylene glycol and difunctional (ethylene glycol-propylene glycol) random components. Polyfunctional polyols having functionality of 4, 5 or more can also be used.

If a polymeric polyol is used, its weight-average molecular weight (Mw) is preferably from 200 to 10,000, more preferably from 500 to 8,000, and most preferably from 1,000 to 6,000. A polymeric polyol having too small a weight-average molecular weight may lower the physical properties of the resulting polyurethane compounds, whereas a weight-average molecular weight that is too large will at time make handling difficult.

The polymeric polyol has a content of polyethylene glycol (EO) units which is at least 20 percent by molar, more preferably at least 30 percent by molar, more preferably at least 50 percent by molar, and most preferably at least 80 percent by molar. Too low a content of polyethylene glycol units may lower the ability of the inventive polymeric compound to dissolve ion-conductive salts.

In the practice of the invention, the above polyol compounds may be used singly or as combinations of two or more thereof. The use of a difunctional polyol in combination with a trifunctional polyol is also possible. The mixing ratio of the difunctional polyol to the trifunctional polyol in this case is preferably 1:25 by weight, although this depends also on the molecular weight of the mixture.

If necessary, use can also be made of a monohydric alcohol. Examples of suitable monohydric alcohols include such as methanol, ethanol, and butanol. Additional exemplary alcohols include but not limited to polypropylene glycol monoethyl ether and polyethylene glycol-propylene glycol monoethyl ether obtained by methyl or ethyl substitution at one end of polyethylene glycol, polypropylene glycol, etc.

In addition to the above-compounds, alcohol compounds having a cyanoethyl group with a large dipole mement is also reacted to form the polyurethane compound of the invention. An example here is ethylene cyanohydrin. Details of this description is disclosed in WO00/56797 and the description of which is incorporated herein.

Furthermore, the ion-conducting polymer and the raw materials of ion-conducting polymer may be mixed together to be used. Here, it is preferable to have semi-interpenetrating polymer network (semi-IPN) structure where the ion-conducting polymer and the raw materials of the ion-conducting polymer do not react each other and that the liner ion-conducting polymer intertwines with the network structured polymer created as a reaction of the raw material. Active materials with the polymer of the semi-IPN structure coated thereon provides the electrode structure excellent electric characteristics because of the higher ion-conductivity and adhesive property of the semi-IPN structured polymer, and therefore such materials are preferable.

It is preferable that the hydroxyalkyl polysaccharides and the derivative are used as the ion-conducting polymer, and the polymer having semi-IPN structure obtained by using the acrylic with reactivity double bond or methacrylic derivative with reactivity double bond is used as the raw material for ion-conducting polymer. More detailed description can be seen in the Japanese Laid-Open Patent Publication No. 8-225626 and the disclosure of which is incorporated herein.

Also, it is preferable that the polyvinylalcohol and the derivative are used as the ion-conducting polymer, and the polymer having semi-IPN structure obtained by using the acrylic with reactivity double bond or methacrylic derivative with reactivity double bond is used as the raw material for ion-conducting polymer. More detailed description can be seen in WO00/57440, WO00/56780, and WO02/087003 and the disclosure of which is incorporated herein.

Further, it is preferable that the polyglycidol and the derivative are used as the ion-conducting polymer, and the polymer having semi-IPN structure obtained by using the acrylic with reactivity double bond or methacrylic derivative with reactivity double bond is used as the raw material for ion-conducting polymer. More detailed description can be seen in WO01/95351, WO00/36017, and WO00/35991 and the disclosure of which is incorporated herein.

The above-examples of polymer and the electrode active substances can effectively be processed through the mixer of this invention and provide the electrode active substances with effectively coated ion-conducting polymer and/or raw material of ion-conducting polymer.

The following sections illustrates examples of the powdered electrode active substance coated with the ion-conducting polymer.

(A) Electrode Structure

Electrode structures are used as electrodes in these electrical components such as a secondary cell and electric double layer capacitor, and exchange electrical charges with ions or draw ions. For this purpose, they have a construction in which a powdered electrode active substance coated with an ion-conducting polymer, is made to adhere to a current-collecting material. For instance, they have a construction in which the powdered electrode active substance used for batteries or a powdered large surface material with a large surface area used for an electric double layer capacitor is made to adhere to a current-collecting material.

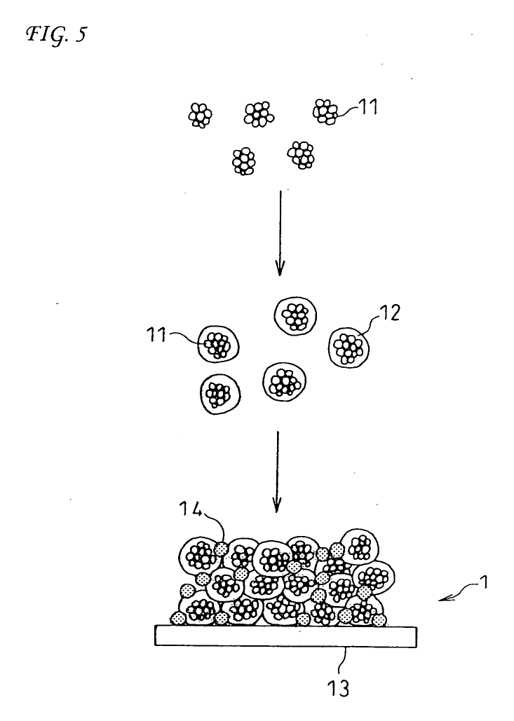

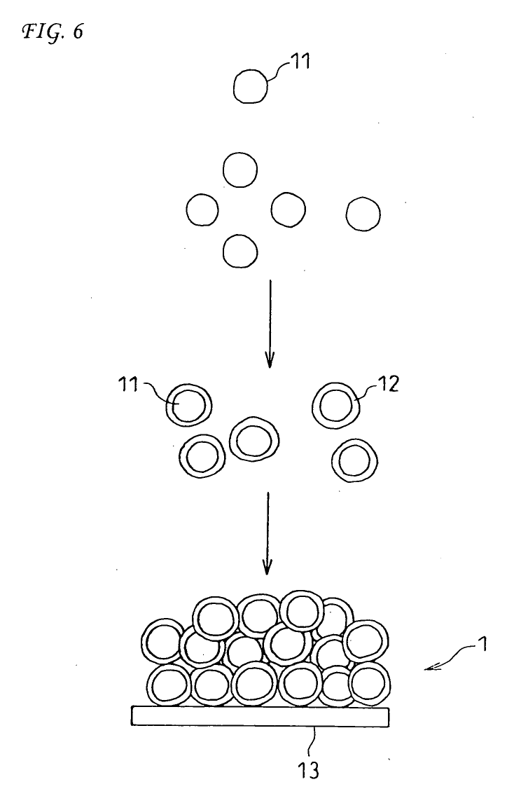

FIG. 5 shows a process for manufacturing an electrode structure 1 wherein a powdered electrode substance, i.e., a powdered electrode active substance 11 comprising particles of a compound such as LiCoO2 is coated with an ion-conducting polymer 12, and is made to adhere to a current-collecting material 13. Likewise, FIG. 6 shows a process for manufacturing the electrode structure 1 wherein a powdered electrode substance, i.e., a powdered electrode active substance 11 having a form such as that of graphite or hard carbon is coated with the ion-conducting polymer 12, and is made to adhere to the current-collecting material 13. A powdered large surface material such as an activated carbon as the powdered large surface material such as an activated carbon as the powdered electrode substance may be coated with the ion-conducting polymer and is adhered to the current-collecting material to form an electrode structure of the electric double layer capacitor.

FIG. 5 shows the case where the electrical conductivity of the powdered electrode active substance 11 is low. The electrical conductivity in the powdered electrode active substance and between the powdered electrode active substance 11 and current-collecting material 13, is increased and the current-collecting efficiency improved by mixing with a powdered electrically-conducting substance 14. The powdered electrically-conducting substance 14 may or may not be coated with the ion-conducting polymer.

“Coating” refers to a state of contact wherein ions can easily migrate between the ion-conducting polymer 12 and the powdered electrode substance, i.e., the powdered electrode active substance 11 over their entire surfaces or the powdered large surface material over their entire surfaces. The ion-conducting polymer 12 is coated on the surface of the powdered electrode active substance 11 or the powdered large surface material so that the latter is covered by the ion-conducting polymer 12. The powdered electrode active substance 11 becomes more active the finer the particles of which it is comprised, but its activity can be suppressed to give greater stability by coating with the ion-conducting polymer 12.

If the layer of the coated ion-conducting polymer 12 is thick, conductivity decreases and current-collecting efficiency is poorer, so it is preferably thin.

The term “powdered” as used in the powdered electrode active substance 11 or the powdered electrically-conducting substance 14, or the powdered large surface material refers to a substance having a fine particle state. In some cases, it may refer to a state wherein a large number of substances having a fine particle state are agglomerated.

(B) Secondary Cell

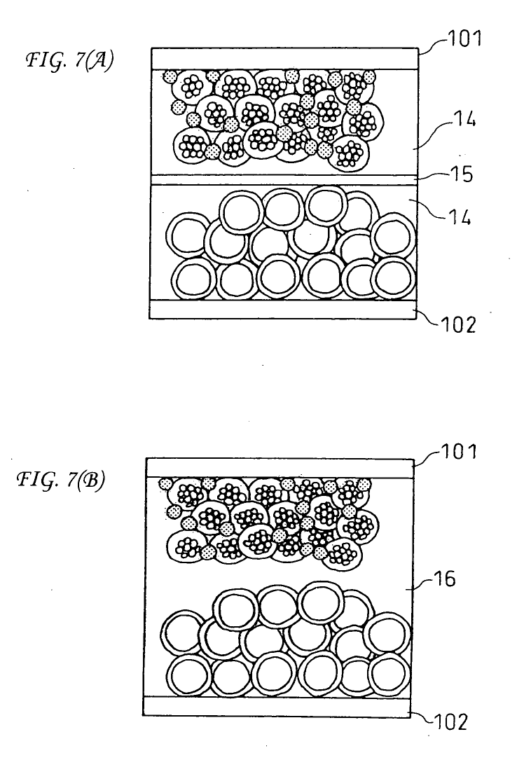

The secondary cell comprises the ion-conducting substance disposed between two types of the electrode structures 1. The secondary cell is formed by introducing a liquid such as the electrolyte 14 between an electrode structure 101 of the positive electrode and an electrode structure 102 of the negative electrode, and disposing a separator 15 between them as shown for example in FIG. 7(A). Alternatively, it is formed by disposing a solid electrolyte substance such as an ion-conducting polymer 16 between the electrode structure 101 of the positive electrode and the electrode structure 102 of the negative electrode as shown in FIG. 7(B).

(C) Electric Double Layer Capacitor

The electric double layer capacitor has a construction in which the powdered large surface material is used to form a pair of electrode structures and an electrolyte substance is disposed between the pair of electrode structures.

The following sections explain a method of manufacturing a powdered electrode active substance coated with an ion-conducting polymer.

(1) Mixer Operation

When the powdered substance 11 is to be coated by the ion-conducting polymer 12, the main blade 22 in close contact with the mortar-shaped bottom surface of the container 21 of the mixer 2 is operated to rotate the main blade 22 at low speed, and the mixture 10 of the ion-conducting polymer or its raw material 121 and the powdered substance 11 is introduced into the container 21. When the mixture 10 is introduced into the gap between the inner bottom surface 211 of the container 21 and the lower surface of the main blade 22, the mixture is pressed and slid therebetween as the main blade 22 rotates, and the ion-conducting polymer or its raw material 121 is coated on the surface of the powdered substance 11.

For effective press-sliding for excellent coating, an area ratio of the lower surface of the main blade 22 facing the inner bottom surface 211 of the container 21 relative to the inner bottom surface is very important and is approximately 5 to 70 percent, preferably 10 to 70 percent, more preferably 15 to 70 percent. Preferable coating results cannot be expected if the area ratio goes below 5 percent or above 70 percent, and no efficient circulation and agitation of the mixture in the container 21 can be expected if the area ratio goes above 70 percent.

In addition to the area ratio, the gap between the inner bottom surface 211 of the container 21 and the lower surface of the main blade 22 is very important and is set as narrow as necessary for effective press-sliding the mixture. The distance between the two surfaces depends upon the capacity of the mixer 2 and the shape of the main blade 22. The distance can be 0.1 to 15 mm, preferably 0.3 to 5.0 mm, more preferably 0.5 to 3.0 mm. Press-sliding efficiency is reduced when the distance is below 0.1 mm or over 15 mm.

A cycle takes place wherein the press-slid mixture 10 temporarily rises up the mortar-shaped lower surface from the inner bottom surface 211 of the container 21 due to the rotation of the main blade 22, then the mixture 10 introduced into the container 21 falls down relative to the risen part and is press-slid between the inner bottom surface 211 of the container 21 and the lower surface of the main blade. A convection of the mixture arises by rotation of the main blade in the container. As a result, the mixture moves upwards from the bottom and falls down from above.

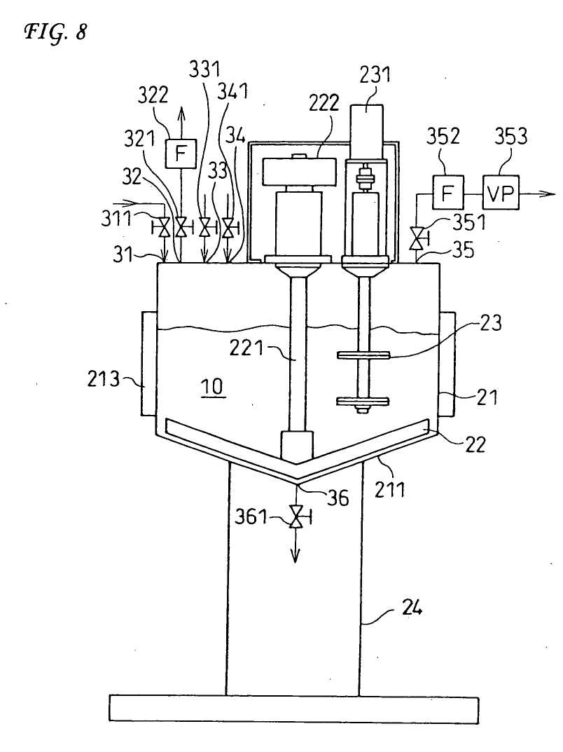

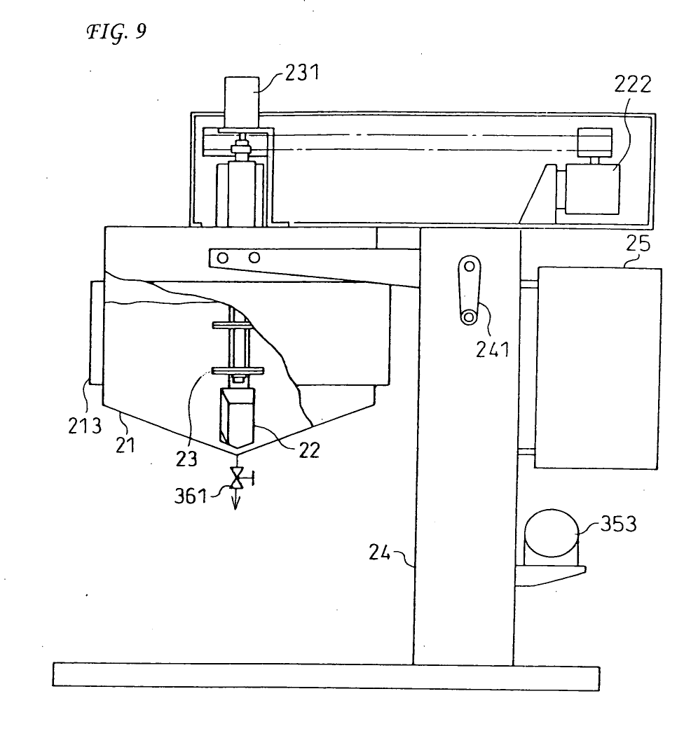

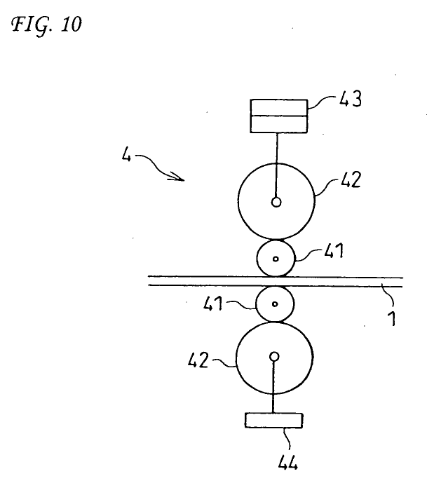

FIG. 8 and FIG. 9 may be used to explain the mixer more specifically. The mixer is supported on the supporting platform 24 and the container 21 is raised by the handle 241 to be controlled by the control panel 25.

First, the powdered substance 11 (containing an additive) is measured out, and introduced from a powdered substance input port 34. In an automated system, a measuring hopper or the like is installed above the powdered substance input port 34 for storage and measurement, and a valve 341 of the powdered substance input port is automatically opened by an input command. Simultaneously, to eliminate measurement errors from pressure rise in the container due to introduction of the powder, a discharge port 32 fitted with an aspiration filter 322 is opened alone so that only air is discharged.

Next, a valve 331 of an input port 33 for the ion-conducting polymer or its raw material is opened, and the polymer or its raw material is measured out manually or automatically and introduced into the container in the same way as the powdered substance. After introduction of the powdered substance and ion-conducting polymer or its raw material is complete, the input valves 331, 341 are closed. Further, if warm water at 30 □ is re-circulated through a jacket 213 of the container to promote wetting of the powdered substance and the ion-conducting polymer or its raw material, the wetting efficiency can be improved. However, when a penetration-assisting solvent is used, processing is performed at ordinary temperature.

Next, the main motor 222 is rotated at a low speed of about 10 rpm, the mixture 10 of the ion-conducting polymer or its raw material and the powdered substance is press-slid between the inner bottom surface 211 of the container 21 and the lower surface of the main blade 22, and the ion-conducting polymer or its raw material gradually begins to permeate relative to the powdered substance. At this time, the press-slid mixture 10 rises up along the inner surface of the container 21; the mixture 10 falls down from above at the center part of the container 21, and a turning over of the mixture 10 takes place on the entire circumference of the container 21. This is repeated regularly so that the whole mixture 10 is uniformly press-slid. After repeating the process for approximately 1 hour, it is preferable that the rotational speed of the main shaft 221 is increased to 60 rpm. When wetting of the mixture 10 has reached effectively half of the surface area, a vacuum pump 353 of a degassing port 35 is may be operated; In this case a degassing valve 351 is opened; and degassing is performed via a filter 352 for about 1 hour. In other words, the main blade 22 press-slides the mixture 10 while degassing is being performed, so the wetting and permeation dispersion of the ion-conducting polymer or its raw material in the powdered substance is promoted. Here, care should be taken when a low boiling-point solvent is added to the ion-conducting polymer or its raw material to promote dispersion in the powdered substance, as the concentration or viscosity of the ion-conducting polymer or its raw material increases and dispersion becomes difficult if suction degassing is continuously performed by a high vacuum blower. When permeation has reached about 70% at a medium speed, the dispersion blade is rotated at 2800 rpm to promote dispersion.

(2) Extraction of Press-Slid Mixture

After the press-sliding process, the powdered substance inlet port valve 341, the ion-conducting polymer inlet port valve 331, a discharge port valve 321 and the degassing port valve 351 are closed. The mixture 10 is pressurized by introducing an air pressure according to the viscosity of the mixture 10 from a pressurizing port 31, for example an air pressure of approximately 5 kg/cm2, and it is then extracted from a discharge port 36.

Alternatively, if a valve 361 of the discharge port 36 is opened alone without pressurizing the container and the main blade 22 is rotated in the reverse direction, the mixture 10 collects in the center part of the container bottom, so the mixture 10 can be discharged naturally from the discharge port 36.

(3) Manufacturing of Electrode Structure

A solvent is added to the press-slid mixture 10 to liquefy it to a paste which is applied to the current-collecting material, and the product is dried to evaporate the solvent. Alternatively, the solvent can be added to the mixture 10 from the beginning and made into a paste as it is subjected to press-sliding.

The press-slid and paste-like resulting substance is thinly applied onto the surface of the current-collecting material. After the application, the solvent evaporates and dries to obtain the electrode structure. An example of a device suitable for applying the press-slid substance onto the current-collecting material include is a doctor knife applicator.

The press-slid substance applied thereon may be pressed against the current-collecting material to make a stronger adhesion. A bonding device 4 may for example be used to achieve stronger adhesion. The press-slid substance can be made to adhere to the current-collecting material by gripping the electrode structure 1 comprising the current-collecting material coated with the press-slid substance between pressure rolls 41, applying a pressure to backup rolls 42 by a pressure device 43, and rotating the rolls.

### DESCRIPTION OF THE PREFERRED EMBODIMENTS

Hereafter, an embodiment of a lithium ion secondary cell will be described.

(a) Example of Manufacture of Positive Electrode Structure (Embodiment 1)

9.1 weight parts of LiCoO2 of average particle size 5 μm, which is a powdered electrode active substance, and 0.6 weight parts of graphite powder of average particle size 4 μm, which is a powdered electrically-conducting substance, were introduced into a press-sliding mixer of the present invention (capacity 300 cc) and then were press-slid for 20 minutes.

In this experiment, the mixer 2 as shown in FIG. 2(A) and the main blade 22 as shown in FIG. 2(B) are used to press-slide the mixture 10. The area ratio of the lower surface of the main blade 22 facing the inner bottom surface 211 of the container 21 relative to the inner bottom surface of the container was approximately 17.4 percent. The distance of the gap between the inner bottom surface 211 of the container 21 and the lower surface of the main blade 22 was approximately 2.0 mm and the pressure angle E of a pressing/contacting surface of the blade 22 relative to the inner bottom surface 211 of the container 21 was approximately 30 degrees. Next, 0.546 weight parts of an ion-conducting polymer raw material (A1)(a) and 3.5 weight parts of acetonitrile were added.

The mixture was press-slid in the mixer 10 for 5 hours. The mixture was in a paste-like condition. 0.254 weight parts of polymeric MDI (MR-200 by NPU Co.), as the raw material of the ion-conducting polymer (A1)(b), was added to the mixture, and the mixture 10 was stirred for 5 minutes in the mixer. The ion-conducting polymer raw material (A1) is comprised of (A1)(a) and (A1)(b) of Table 1 and the mixing ratio are shown in Table 1. The mixture was transferred on aluminum foil of thickness 20 μm, and spread by the doctor knife applicator of 100 μm gap. The resulting product was left at room temperature for 15 minutes, and then heated at 80° C. for 1 hour. The thickness of the positive electrode structure obtained was 80 μm. The same effectiveness is seen when spreading by a doctor knife applicator of 200 μm gap.

[Table 1]

The same type of mixer and blade as used in the embodiment 1 was used in the following embodiments 2-6 and comparative examples 1-2.

(b) Example of Manufacture of Positive Electrode Structure (Embodiment 2)

9.0 weight parts of LiCoO2 of average particle size 5 μm, which is a powdered electrode active substance, and 0.6 weight parts of ketjenblack and 0.2 weight parts of graphite powder of average particle size 4 μm, which are powdered electrically-conducting substances, were introduced into the mixer and were press-slid for 20 minutes. Next, 1.172 weight parts of an ion-conducting polymer raw material (A1)(a) and 3.5 weight parts of acetonitrile were added. These mixtures were press-slid for 5 hours in the press-sliding mixer. The mixture was in a paste-like condition. 0.548 weight parts of polymeric MDI (MR-200 by NPU Co.), as the ion-conducting polymer raw material (A1)(b), was added to the mixture, and the mixture was press-slid for 5 minutes. The mixture was transferred on aluminum foil of thickness 20 μm, and spread by a doctor knife applicator of 250 μm gap. The resulting product was left at room temperature for 15 minutes, and heated at 80° C. for 1 hour.

The thickness of the electrode obtained was 80 μm. The same effectiveness is seen by the use of 10.0 weight parts of acetonitrile and spreading a doctor knife applicator or 250 μm gap.

(c) Example of Manufacture of Positive Electrode Structure (Embodiment 3)

9.1 weight parts of LiCoO2 of average particle size 5 μm which is a powdered electrode active substance, 0.341 weight parts of the ion-conducting polymer raw material (A1)(a) and 3.0 weight parts of acetonitrile were introduced into the mixer and the mixture was press-slid for 7 hours. The mixture was in a paste-like condition. Next, 0.159 weight parts of polymeric MDI (MR-200 by NPU Co.), as the ion-conducting polymer raw material (A1)(b), was added, and the mixture was press-slid for 5 minutes. The mixture was transferred on aluminum foil of thickness 20 μm, and spread by a doctor knife applicator of 100 μm gap. The resulting product was left at room temperature for 15 minutes, and heated at 80° C. for 1 hour. The thickness of the electrode obtained was 80 μm. The same effectiveness is seen when spreading by a doctor knife applicator of 200 μm gap.

(d) Example of Manufacture of Positive Electrode Structure (Embodiment 4)

9.1 weight parts of LiCoO2 of average particle size 5 μm, which is a powdered electrode active substance, and 0.6 weight parts of graphite powder of average particle size 4 μm, which is a powdered electrically-conducting substance, were introduced into the mixer device, and press-slid for 20 minutes. Next, 2.0 weight parts of the raw material of the ion-conducting polymer (A2) and 3.0 weight parts of acetonitrile were added. The ion-conducting polymer raw material (A2) was a mixture, and its composition and mixing ratio are shown in Table 2. In the Table 2, the same result may be obtained by the use of polyethleneglycoldimethacrylate (536 molecular weight) instead of trimethylolpropanetrimethacrylate.

[Table 2]

The mixture, to which the ion-conducting polymer raw material (A2) was added, was press-slid in the mixer or 5 hours. The mixture was in a paste-like condition. A solution of 0.01 weight parts of 2,2′-azobis (2,4-dimethylvaleronitrile) and 0.5 weight parts of a (1/1) vol. liquid electrolyte of ethylene carbonate (EC)/diethylene carbonate (DEC) was added to the mixture, and the mixture was further press-slid for 5 minutes. The mixture was transferred on aluminum foil of thickness 20 μm, and spread by a doctor knife applicator of 100 μm gap. The resulting product was left at room temperature for 15 minutes, and heated at 80° C. for 3 hours. The thickness of the electrode obtained was 80 μm. The same effectiveness may be expected by the use of 0.5 weight parts of the ion-conducting polymer raw material (A2), 0.003 weight parts of 2,2′-azobis(2,4-dimethylvaleronitrile), and by spreading a doctor knife applicator of 200 μm gap.

(e) Example of Manufacture of Negative Electrode Structure (Embodiment 5)

9.1 weight parts of graphite powder of average particle size 5 μm, which is a powdered electrode active substance, 0.341 weight parts of ion-conducting polymer raw material (A1)(a) and 3.0 weight parts of acetonitrile were introduced into the mixer, and the mixture was press-slid for 7 hours. The mixture was in a paste-like condition. Next, 0.159 weight parts of polymeric MDI (MR-200 by NPU Co.), as the ion-conducting polymer raw material (A1)(b), was added, and the mixture press-slid for 5 minutes. The mixture was transferred on copper foil of thickness 20 μm, and spread by a doctor knife applicator of 100 μm gap. The resulting product was left at room temperature for 15 minutes, and heated at 80° C. for 1 hour. The thickness of the electrode obtained was 80 μm. The same effectiveness may be expected by the use of 10.0 weight parts of the acetonitrile and spreading a doctor knife applicator of 250 μm gap.

(f) Example of Manufacture of Positive Electrode Structure (Embodiment 6)

9.1 weight parts of graphite powder of average particle size 5 μm, which is a powdered electrode active substance, 0.2 weight parts of an ion-conducting polymer raw material (A2) and 3.0 weight parts of acetonitrile were introduced into the mixer, and press-slid for 5 hours. The mixture was in a paste-like condition. A solution of 0.01 weight parts of 2,2′-azobis (2,4-dimethylvaleronitrile) and 0.5 weight parts of a liquid electrolyte of ethylene carbonate (EC)/diethylene carbonate (DEC) in a volume ratio of 1:1 was added to the press-slid substance, and the mixture was further press-slid for 5 minutes. The press-slid substance was transferred on copper foil of thickness 20 μm, and spread by a doctor knife applicator of 100 μm gap. The resulting product was left at room temperature for 15 minutes, and heated at 80° C. for 3 hours. The thickness of the electrode obtained was 80 μm. The same effectiveness may be expected by the use of 0.8 weight parts of the ion-conducting polymer raw material (A2), 10.0 weight parts of acetonitrile, 0.004 weight parts of 2,2′-azobis (2,4-dimethylvaleronitrile), and by spreading a doctor knife applicator of 250 μm gap.

(g) Analysis of Electrode Structure

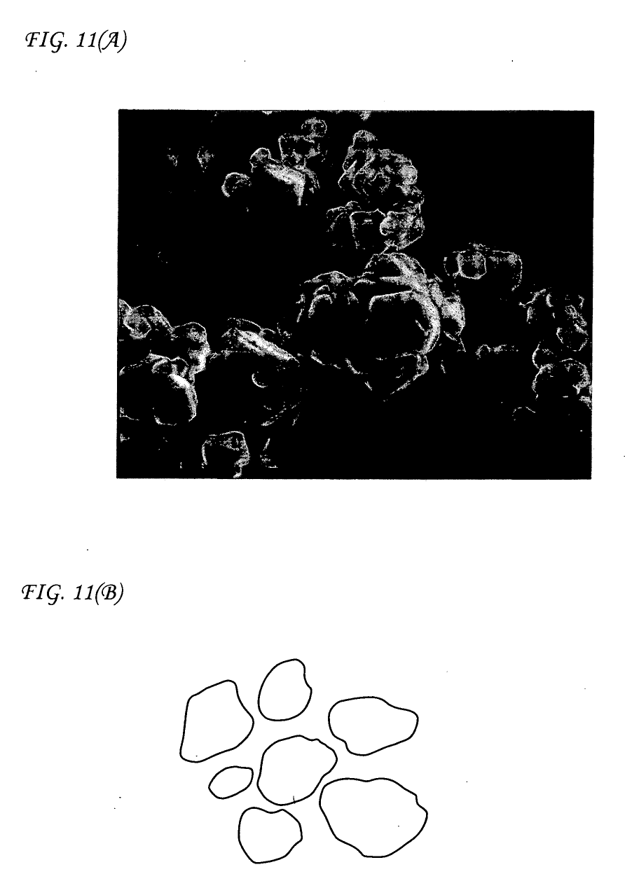

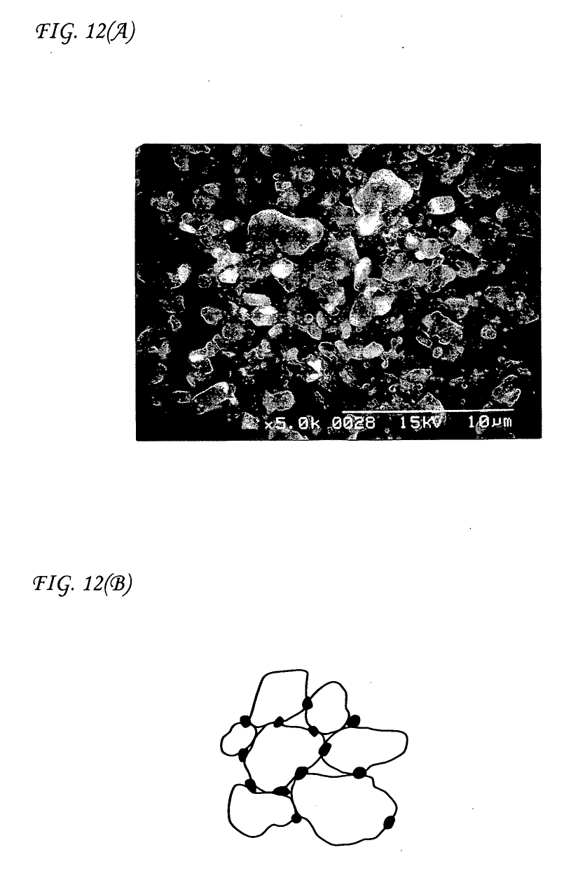

FIG. 11(A) shows an 5000 times magnified electron micrograph of LiCoO2 of average particle size 5 μm which had not received any processing. In FIG. 11(B), the corners of the compound particles of LiCoO2 are square and clearly visible. The electron micrograph of FIG. 12(A) is an electron micrograph of the positive electrode structure obtained in Comparative Example 3. In FIG. 12(B), the corners of the compound particles of LiCoO2 are still partly square, and appear to be partly covered by a film.

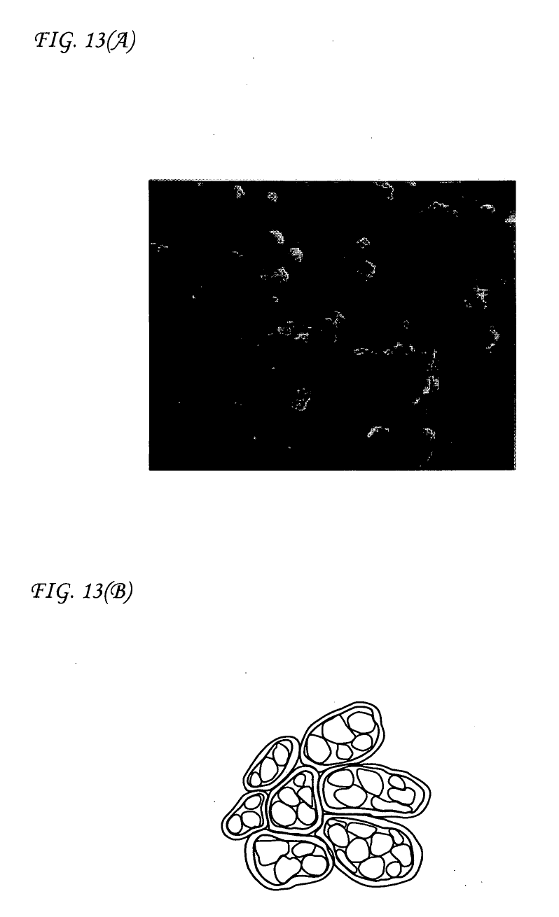

The electron micrograph of FIG. 13(A) is an electron micrograph of the positive electrode structure obtained in Example 3. In FIG. 13(B), the corners of the compound particles of LiCoO2 are smooth, and appear to be entirely and uniformly covered by a film.

Hence, comparing the LiCoO2 in FIG. 13 with the LiCoO2 in FIG. 11 or 12, it is evident that the LiCoO2 particles in FIG. 13 are uniformly covered with a film of ion-conducting polymer.

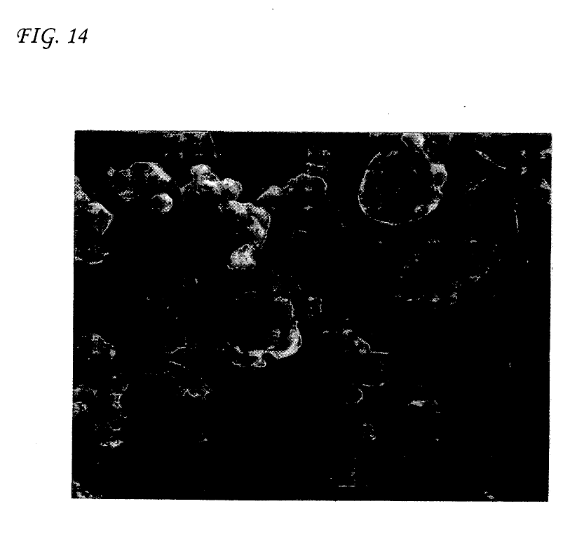

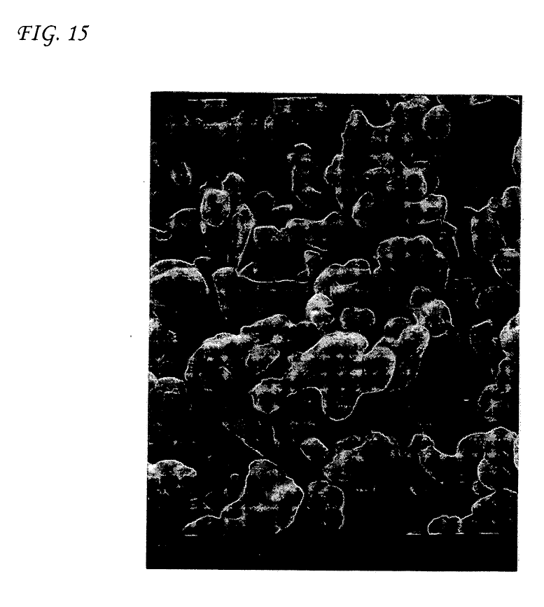

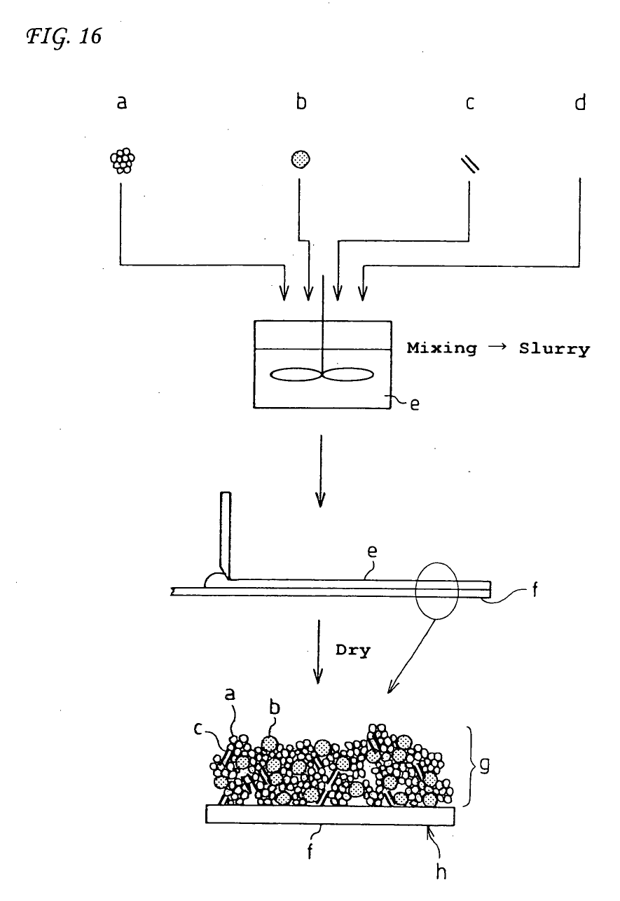

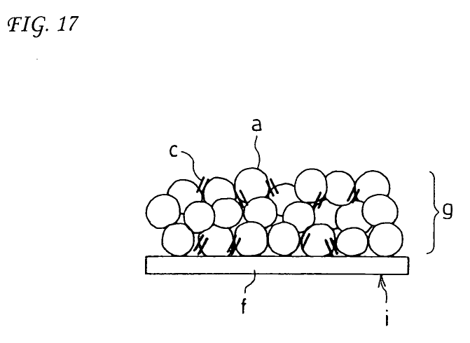

FIG. 14 shows a 5000 times magnified two-dimensional electronic image of the surface of the positive electrode structure obtained in Example 3 measured by a Shimadzu EPMA-8705 Electron Probe Micro-Analyzer. The particles of FIG. 14 have smooth corners and appear to be covered by a coating of ion-conducting polymer.

(h) Example of Manufacturing Positive Electrode Structure

### COMPARATIVE EXAMPLE 1

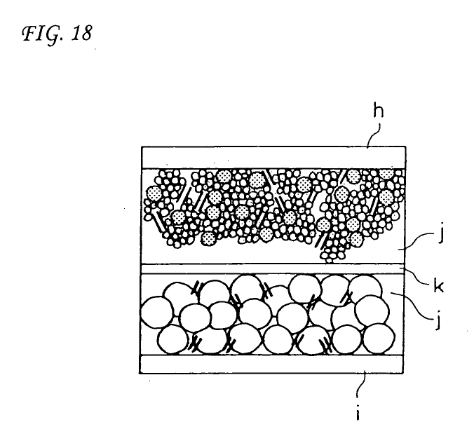

11.5 weight parts of n-methylpyrrolidine containing, in solution, 0.5 weight parts of polyvinylidene fluoride (PVDF) which has no ion-conducting property as a polymer binder, was mixed with 9.0 weight parts of LiCoO2 of average particle size 5 μm which is a powdered electrode active substance, and 0.8 weight parts of ketjenblack and 0.2 weight parts of graphite powder of average particle size 4 μm which are powdered electrically-conducting substances, in an ordinary blade mixer as shown in FIG. 18. After mixing for 8 hours, the mixture was transferred on copper foil of thickness 20 μm, and spread by a doctor knife applicator of 100 μm gap. The resulting product was then heated to evaporate n-methylpyrrolidine. The thickness of the electrode obtained was 80 μm. The same result was attained by the use of 5.0 weight parts of n-methylpyrrolidine and spreading a doctor knife applicator of 200 μm gap.

(i) Example of Manufacturing Negative Electrode Structure

### COMPARATIVE EXAMPLE 2

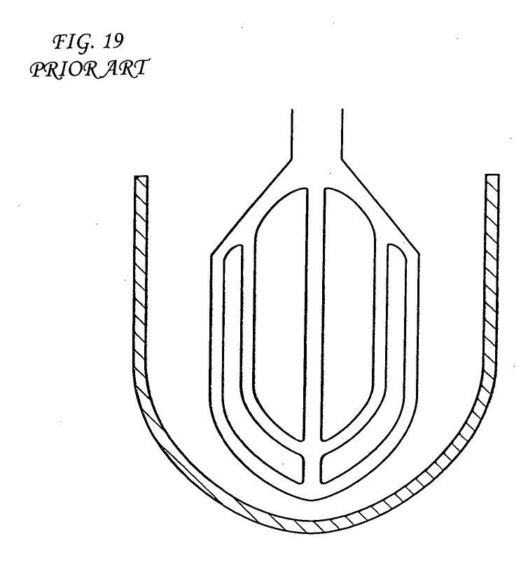

25.5 weight parts of n-methylpyrrolidine containing, in solution, 0.5 weight parts of polyvinylidene fluoride (PVDF) which has no ion-conducting property as a polymer binder, was mixed with 9.5 weight parts of graphite powder of average particle size 4 μm which is a powdered electrically-conducting substance, in an ordinary blade mixer as shown in FIG. 19. After mixing for 8 hours, the mixture was transferred on copper foil of thickness 20 μm, and spread by a doctor knife applicator of 100 μm gap. The resulting product was then heated to evaporate n-methylpyrrolidine. The thickness of the electrode obtained was 80 μm. The same result was attained by the use of 10.0 weight parts of n-methylpyrrolidine containing, in solution, 1.0 weight parts of polyvinylidene fluoride (PVDF) and spreading a doctor knife applicator of 250 μm gap.

(j) Example of Manufacturing Positive Electrode Structure

### COMPARATIVE EXAMPLE 3

In this comparative example 3, an ordinary blade mixer as shown in FIG. 19 was used instead of the mixer of the embodiment 1. All other conditions for manufacturing the positive electrode structure are same as in the embodiment 3. The resulted electrode thickness is 80 μm and the same result was attained by the use of a doctor knife applicator of 200 μm gap.

(k) Example of Manufacturing Positive Electrode Structure

### COMPARATIVE EXAMPLE 4

In this comparative example 4, an ordinary blade mixer as shown in FIG. 19 was used instead of the mixer of the embodiment 1. All other conditions for manufacturing the positive electrode structure are same as in the embodiment 2. The resulted electrode thickness is 80 μm and the same result was attained by the use of a doctor knife applicator of 200 μm gap.

(l) Example of Manufacturing Negative Electrode Structure

### COMPARATIVE EXAMPLE 5

In this comparative example 5, an ordinary blade mixer as shown in FIG. 19 was used instead of the mixer of the embodiment 5. All other conditions for manufacturing the positive electrode structure are same as in the embodiment 5. The resulted electrode thickness is 80 μm and the same result was attained by the use of a doctor knife applicator of 200 μm gap.

(m) Charging/Discharging Tests

A lithium ion secondary cell was manufactured using the positive electrode structures manufactured in the examples and comparative examples. The positive electrode and negative electrode were both cut out to have an electrode surface area of 4 cm2. Completely solid polymer electrolyte (all polymer), or polymer gel electrolyte (polymer gel), and a separator were sandwiched between the positive electrode and negative electrode to manufacture the test cell. The concentration of lithium salt (supporting electrolyte salt) in the respective electrolytes was arranged to be 1M. This cell was charged at 0.3 mA per 1 cm2 of electrode surface area to 4.1V, and after allowing to stand for 15 minutes, it was discharged at 0.3 mA/cm2 to 2.7V. Combinations of positive and negative electrodes for which two of these charging/discharging cycles were successfully performed, were considered to be combinations for which charging/discharging is possible, and results are shown in Table 3. Table 4 shows the contents of the electrolytes listed in Table 3. The same result was obtained as the thickness of the electrolyte is 20 μm at P1-AP4 and 30 μm at PG1-PG2.

[Table 3]

[Table 4]

In the charging/discharging tests of the examples and comparative examples, test cells using the positive electrode and negative electrode of this invention could be successfully charged and discharged. However, test cells using the electrodes of the comparative examples and a solid or gel electrolyte could not be charged/discharged.

(n) Example of Manufacturing Positive Electrode Structure

### EMBODIMENTS 7-13 AND COMPARATIVE EXAMPLE 6

The following Table 5 shows results of experimenting the press-sliding effect of the mixer comprising different types of blades with different blade area ratio R(%) of the lower surface of the blade relative to the inner bottom surface of the container and different distance between the lower surface of the blade and the inner bottom surface of the container. All other conditions except for the above differences are same as set in the embodiment 3. The blades in the embodiments 7-10 are same as the blade in FIG. 2(B) with different width changing the area ratio R(%). Table 5 shows the measurement of the fifth cycle charging-discharging ratio (%) under press-sliding at 1 hour, 3 hours, 5 hours, and 7 hours. In addition, a cycle maintenance factor (ratio) was measured at the end of the 100th cycle. Electrolyte used in charging-discharging is PG1 polymer gel as shown in FIG. 4. Preferable charging-discharging ratio (%) was obtained in the embodiments 7-13 while charging-discharging cannot be performed in the comparative example 6. The results are shown in FIG. 5.

(n) Example of Electrode Structure for Capacitor

An electrode structure for capacitor is manufactured by introducing 0.6 weight parts of carbon black as the powdered conducting substance in 9.1 weight parts of phenol activated carbon (manufactured by Kansai Kagaku Corporation) as the powdered large surface electrode substance in the press-sliding mixer, the same as used in Embodiment 1 and dry-mixing with a mixing container for 20 minutes. 10.546 weight parts of the ion-conducting polymer raw material (A1)(a) are added as the binder to be mixed for 5 hours. Then, 0.548 weight parts of polymeric MDI (MR-200 by NPU Co.), as the ion-conducting polymer raw material (A1)(b), and 7.8 weight parts of acetonitrile as a solvent were added to be mixed. After this mixing process, the doctor knife applicator is used to apply on the current-collecting material to be dried out. The thickness of the electrode was 75 μm, which showed the excellent charging-discharging characteristics of the capacitor with this electrode structure.

This invention makes it possible to obtain a device (or mixer) wherein a powdered substance is efficiently coated by an ion-conducting polymer and a method whereby a powdered substance is efficiently coated by an ion-conducting polymer. It is readily apparent that the above-described embodiments have the advantage of wide commercial utility. It should be understood that the specific form of the invention hereinabove described is intended to be representative only, as certain modifications within the scope of these teachings will be apparent to those skilled in the art. Accordingly, reference should be made to the following claims in determining the full scope of the invention.

Tables

TABLE 1
Ion-conducting polymer raw material (A1)

| | | Mixing ratio |
|---|---|---|
| | | (weight |
| | Substance | parts) |
| (a) | Trifunctional (propylene glycol/ethylene glycol) | 5.71 |
| | random copolymer, SANNIX FA-103 (PO/EO = 2/8, | |
| | Mw = 3,282, Sanyo Chemical Industries, Ltd.) | |
| | Trifunctional polyol, 1,4-butadiol | 0.23 |
| | Ethylene cyanohydrin | 0.87 |
| | Reaction catalyst NC-IM (Sankyo Air Products | 0.02 |
| | K.K.) | |
| (b) | Polymeric MDI | 3.17 |
| | Total | 10 |

TABLE 2
Ion-conducting polymer raw material (A2)

| | Mixing ratio |
|---|---|
| | (weight |
| Substance | parts) |
| Cyanoethylated/dihydroxypropylated polyvinyl alcohol | 0.625 |
| Methoxypolyethyleneglycol methacrylate (mol. wt. 468) | 3.125 |
| Trimethylolpropanetri methacrylate | 6.25 |
| Total | 10 |

TABLE 3
Charging/discharging test results

| | Positive | Negative | | Charging/discharging |
|---|---|---|---|---|
| No | electrode | electrode | Electrolyte | test result |
| 1 | Example 1 | Example 5 | AP1 | Possible |
| 2 | Example 1 | Example 5 | AP2 | Possible |
| 3 | Example 1 | Example 5 | AP3 | Possible |
| 4 | Example 1 | Example 5 | AP4 | Possible |
| 5 | Example 1 | Example 5 | PG1 | Possible |
| 6 | Example 1 | Example 5 | PG2 | Possible |
| 7 | Example 1 | Example 5 | L1 | Possible |
| 8 | Example 2 | Example 5 | AP3 | Possible |
| 9 | Example 2 | Example 6 | PG2 | Possible |
| 10 | Example 4 | Example 5 | AP3 | Possible |
| 11 | Example 4 | Example 6 | PG2 | Possible |
| 12 | Comparative | Comparative | AP1 | Charging/discharging |
| | example 1 | example 2 | | impossible |
| 13 | Comparative | Comparative | AP2 | Charging/discharging |
| | example 1 | example 2 | | impossible |
| 14 | Comparative | Comparative | AP3 | Charging/discharging |
| | example 1 | example 2 | | impossible |
| 15 | Comparative | Comparative | AP4 | Charging/discharging |
| | example 1 | example 2 | | impossible |
| 16 | Comparative | Comparative | PG1 | Charging/discharging |
| | example 1 | example 2 | | impossible |
| 17 | Comparative | Comparative | PG2 | Charging/discharging |
| | example 1 | example 2 | | impossible |
| 18 | Comparative | Comparative | AP1 | Charging/discharging |
| | example 4 | example 5 | | impossible |
| 19 | Comparative | Comparative | AP2 | Charging/discharging |
| | example 4 | example 5 | | impossible |
| 20 | Comparative | Comparative | AP3 | Charging/discharging |
| | example 4 | example 5 | | impossible |
| 21 | Comparative | Comparative | AP4 | Charging/discharging |
| | example 4 | example 5 | | impossible |
| 22 | Comparative | Comparative | PG1 | Charging/discharging |
| | example 4 | example 5 | | impossible |
| 23 | Comparative | Comparative | PG2 | Charging/discharging |
| | example 4 | example 5 | | impossible |

TABLE 4
Electrolyte used in test

| Symbol | Type | Composition | Thickness |
|---|---|---|---|
| AP1 | All polymer | Cyanoethylated/dihydroxypropylated | 100 μm |
| | | cellulose | |
| | | (e.g. Japanese Patent Application | |
| | | Laid-Open No. 8-225626) | |
| AP2 | All polymer | Cyanoethylated/dihydroxypropylated | 100 μm |
| | | cellulose and methacryl polymer 3D | |
| | | cross-linked structure | |
| | | (e.g. Japanese Patent Application | |
| | | Laid-Open No. 8-225626) | |
| AP3 | All polymer | High viscosity polyurethane | 100 μm |
| | | electrolyte (e.g. Japanese Patent | |
| | | Application No. 11-78085) | |
| AP4 | All polymer | Cyanoethylated/dihydroxypropylated | 100 μm |
| | | polyvinyl alcohol | |
| | | (e.g. Japanese Patent Application No. | |
| | | 11-78086) | |
| PG1 | Polymer | Cyanoethylated/dihydroxypropylated | 100 μm |
| | gel | polyvinyl alcohol and methacryl | |
| | | polymer 3D cross-linked structure | |
| | | containing 50% ethylene carbonate | |
| | | (EC)/diethylene carbonate (DEC) | |
| | | = (1/1) vol. liquid electrolyte | |
| | | (e.g. Japanese Patent | |
| | | Application No. 11-78087) | |
| PG2 | Polymer | High viscosity polyurethane | 100 μm |
| | gel | electrolyte containing 50% | |
| | | ethylene carbonate | |
| | | (EC)/diethylene carbonate (DEC) = | |
| | | (1/1) vol. liquid electrolyte | |
| | | (e.g. Japanese Patent Application No. | |
| | | 11-78085) | |

TABLE 5

| | | | | Press-slide time and | | | | Cycle |
|---|---|---|---|---|---|---|---|---|
| | | | | charge-discharge ratio | | | | maintenance |
| | | Area | | (%) | | | | ratio |
| | Types of | ratio | Distance | 1 | 3 | 5 | 7 | 100 |
| | Blade | R(%) | (mm) | hour | hours | hours | hours | cycles |
| Embodiment 7 | FIG. 2(B)(1) | 5.6 | 2.0 | 66.1 | 70.5 | 84.2 | 85.7 | 53 |
| Embodiment 8 | FIG. 2(B)(2) | 11.05 | 2.0 | 72.2 | 88 | 96.3 | 97.1 | 74 |
| Embodiment 9 | FIG. 2(B)(3) | 17.39 | 2.0 | 85.5 | 93.8 | 99.5 | 99.5 | 94 |
| Embodiment 10 | FIG. 2(B)(4) | 25.47 | 2.0 | 87 | 95.1 | 99.4 | 99.4 | 94 |
| Embodiment 11 | FIG. 4(A) | 33.5 | 1.0 | 78.1 | 89.9 | 94.8 | 95.3 | 71 |
| Embodiment 12 | FIG. 3(B) | 49.42 | 1.5 | 83.3 | 97.1 | 99.3 | 99.3 | 90 |
| Embodiment 13 | FIG. 4(B) | 63.24 | 1.5 | 80.5 | 96.5 | 98.9 | 99.1 | 87 |
| Comparative | | 1.3 | 0-85 | — | — | — | — | — |
| example 6 | | | | | | | | |

What is claimed is:

1. A mixer for mixing a mixture of an ion-conducting polymer and/or an ion-conducting polymer raw material with a powdered substance and for coating the ion-conducting polymer on the powdered substance, comprising:
a container, which holds the mixture inside, and
at least one main blade, which faces with an inner bottom surface of the container and rotates relative to the inner bottom surface so as to press-slide the mixture between said lower surface of said main blade and said inner bottom surface of the container, wherein
an area ratio of said lower surface of the main blade relative to said inner bottom surface of the container is 5 to 70 percent.

2. The mixer according to claim 1, wherein
said area ratio is 10 to 70 percent.

3. The mixer according to claim 1, wherein
said area ratio is 15 to 70 percent.

4. The mixer according to claim 1, wherein
a gap exists between said lower surface of the main blade and said inner bottom surface of the container.

5. The mixer according to claim 4, wherein said gap is constant.

6. The mixer according to claim 4, wherein
said gap distance from said lower surface of the main blade to said inner bottom surface of the container is 0.1 to 15 mm.

7. The mixer according to claim 4, wherein
said gap distance from said lower surface of the main blade to said inner bottom surface of the container is 0.3 to 5.0 mm.

8. The mixer according to claim 4, wherein
said gap distance from said lower surface of the main blade to said inner bottom surface of the container is 0.5 to 3.0 mm.

9. The mixer according to claim 1, further comprising
a scraping member for removing the mixture adhered to the lateral surface of said container.

10. The mixer according to claim 9, wherein
said scraping member is disposed on said main blade while facing a lateral surface of said container.

11. The mixer according to claim 1, wherein
said main blade is disc-shape.

12. The mixer according to claim 11, wherein
said disc-shaped main blade has at least one through hole.

13. The mixer according to claim 11, wherein
said disc-shaped main blade has at least one notched groove.

14. The mixer according to claim 1, wherein
said main blade is a wide plate blade.

15. The mixer according to claim 1, wherein
an action of reversing the rotational direction of said main blade is repeated.

16. The mixer according to claim 1, wherein
said inner bottom surface has a base portion around the lowest part and a slope surface extending upward from said base portion; and
said main blade is positioned above and pivots around said base portion.

17. The mixer according to claim 1, wherein
an angle of a surface in the motion direction of said main blade relative to said inner bottom surface of the container is an acute angle.

18. The mixer according to claim 1, wherein
a surface opposite to the motion direction of said main blade is almost perpendicular to the inner bottom surface of the container.

19. The mixer according to claim 1, wherein
an angle of a surface opposite to the motion direction of said main blade relative to the inner bottom surface of the container is an obtuse angle.

20. The mixer according to claim 1, further comprising
a dispersion blade in the container.

21. A method for coating an ion-conducting polymer or a the ion-conducting polymer raw material on a powdered substance, comprising steps of:
introducing a mixture of the ion-conducting polymer or ion-conducting polymer raw material with the powdered substance in a container;
introducing a portion of the mixture in a gap between an inner bottom surface of the container and a lower surface of a blade, where the area ratio of said lower surface of the blade relative to said inner bottom surface of the container is 5 to 70 percent; and
press-sliding the mixture in said gap so as to make the ion-conducting polymer or ion-conducting polymer raw material adhere to a powdered substance.

22. The method according to claim 21, further comprising steps of:
press-sliding the mixture in said gap between the inner bottom surface of the container and the lower surface of the main blade; and
circulating said mixture to go up and down within the container to repeatedly press-slide the mixture.

23. The method according to claim 21, wherein
a solvent is added to the mixture.

24. The method according to claim 21, wherein
introducing the mixture in a container;
press-sliding the mixture by the main blade against the inner bottom surface of the container; and
dispersing the mixture by a dispersion blade.

25. The method according to claim 21, wherein
said main blade initially rotates in low speed in order to conduct press-sliding.

26. The method according to claim 21, wherein
said container is subject to degassing when wetting of the mixture becomes about half of the surface area.
